(19) United States
(12) Patent Application Publication
(10) Pub. No.: US 2009/0265574 A1
(43) Pub. Date: Oct. 22, 2009

(54) Systemic Frequency Adjusting Method for Storage Device

(76) Inventor: Che Yi Lin, Pingjhen City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 12/144,964

(22) Filed: Jun. 24, 2008

(30) Foreign Application Priority Data
Mar. 26, 2008 (TW) 097110761

(51) Int. Cl. G06F 1/04

(52) U.S. Cl. 713/503

(57) ABSTRACT

A method of adjusting systemic frequency in a storage device, wherein a command is provided by a computer system to count the number of the clock pulses in a set time period of the computer system and the storage device; the value of correction of the systemic frequency of the storage device is obtained by calculation of the computer system, then the value of correction is stored in a storing medium; and the systemic frequency of the storage device is adjusted by the system operating clock frequency adjusting unit according to the value of correction of the systemic frequency, so that the systemic frequency of the storage device can be controlled within a predetermined range that meets the requirement for a device with higher system performance specification, and thereby the cost of production can be reduced.

### BACKGROUND OF THE INVENTION

1. Field of the Invention

The present invention relates to a system operating clock frequency adjusting unit, and especially to a method of adjusting systemic frequency in a storage device according to a systemic correcting value stored in a storing medium using a system operating clock frequency adjusting unit.

2. Description of the Prior Art

To make a CPU, a memory and various peripheral equipment work together precisely without error, particularly to make no error in data exchange or mutual connection, for a 3C product such as a computer system of a computer or a storing device etc., a fixed frequency is needed to be a common norm for timing that is used as a reference for correction or coordination.

In earlier products, the mode of hanging an external quartz oscillator surely can generate a precise systemic frequency, however, for the purpose of reducing cost, some manufacturers directly made RC oscillating circuits on chips of silicon wafers; although this can also generate systemic frequencies, by the material used or the variation during the processes of manufacturing, drift of frequencies may often be created in various chips of an identical silicon wafer, thus the Chips are unable to completely meet the requirement for a device with higher system performance specification.

For solving the above stated problem, some manufacturers added in advance several mutually matched electric resistances during IC chip manufacturing, and after manufacturing, the frequencies are tested to know their levels, and the input frequencies are treated by the mode of trimming welding spots to make them meet the requirement of the standard; alternatively, the RC oscillating circuits are provided therein with several read-only storages that are electrically erasable programmable (EEPROM), and during the process of testing, a value of resistance is filled in the EEPROM, in order that the frequencies in the range of the standard are input, so that the object of frequency correction can be achieved

In a practical processes of manufacturing, although the above two modes can both effectively adjust the output frequencies, increasing extra times of welding spots and singly testing chips may increase the cost of chip manufacturing; moreover, building of the EEPROM in the IC chips not only can increase the extra time of testing chips, but also can occupy the areas that the chips use, these are not desired.

In view of the above stated, and for improving the case having the above defects to make the adjusting method for the systemic frequency of a storage device able to directly use the structure built in the storage device for adjusting the systemic frequencies output from the chips to reach the range of the standard. The inventor studied without stopping for many years and thus developed the present invention.

### SUMMARY OF THE INVENTION

The primary object of the present invention is to provide a method of adjusting systemic frequency in a storage device, by using a system operating clock frequency adjusting unit and according to a systemic correcting value stored in a storing medium to adjust the systemic frequency generated by an RC oscillating circuit in a storage device, the systemic frequency of the storage device can be controlled within a predetermined range that meets the requirement for a device with higher system performance specification.

The secondary object of the present invention is to provide a method of adjusting systemic frequency in a storage device, wherein after forming a chip that is used to generate systemic frequency, a system operating clock frequency adjusting unit is used to adjust the systemic frequency generated by an RC oscillating circuit in the storage device, in order to avoid increasing extra times of testing chips or electronic components during the processes of manufacturing IC chips, and thereby to effectively reduce the cost of production.

For achieving the above mentioned objects, the method of adjusting systemic frequency in a storage device of the present invention comprises the following steps: a. a command is provided by a computer system to count the number of the clock pulses in a set time period of the computer system and the storage device; b. the value of correction of the systemic frequency of the storage device is obtained by calculating in reference to the systemic frequency of the computer system, then the value of correction is stored in a storing medium; and c. the systemic frequency of the storage device is adjusted by the system operating clock frequency adjusting unit according to the value of correction of the systemic frequency.

When in practicing, the value of correction of the systemic frequency is a value obtained by the computer system by calculating according to the systemic frequency of the storage device. The formula of calculation of the systemic frequency of the storage device is as below:

the systemic frequency of the storage device=(the number of the clock pulses of the storage device/the number of the clock pulses of the computer system)×the systemic frequency of the computer system

When in practicing, the system operating clock frequency adjusting unit includes a register in order to adjust the systemic frequency of the storage device after receiving the value of correction of the systemic frequency stored in the storing medium.

And when in practicing, the register adjusts the systemic frequency generated by the RC oscillating circuit in the storage device by means of a frequency adjuster, or directly adjusts RC values of an adjustable RC oscillating circuit in the storage device, to thereby change the systemic frequency generated by the RC oscillating circuit.

The present invention will be apparent after reading the detailed description of the preferred embodiment thereof in reference to the accompanying drawings.

### BRIEF DESCRIPTION OF THE DRAWINGS

FIG. 1 is a flow chart showing a preferred embodiment of the method of adjusting systemic frequency in a storage device of the present invention;

FIG. 2 is a block diagram showing an electric circuit of the preferred embodiment of the present invention;

FIG. 3 is a block diagram showing an electric circuit for another way of practicing the step c. of the present invention.

### DETAILED DESCRIPTION OF THE PREFERRED EMBODIMENT

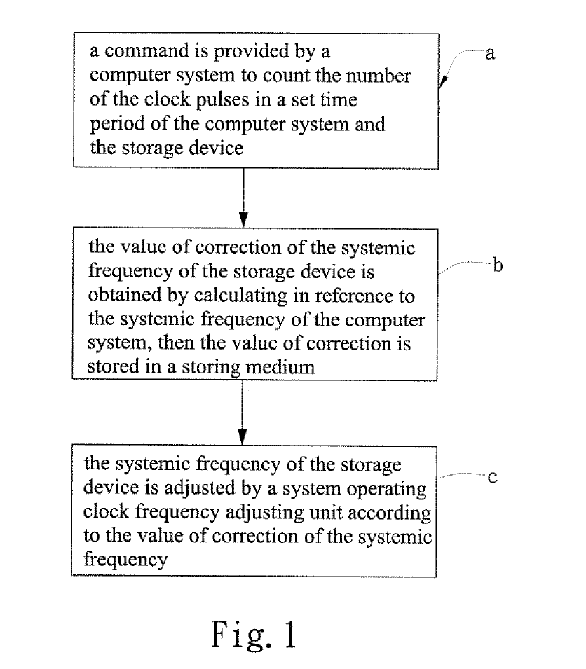

Referring firstly to FIG. 1 showing a preferred embodiment of the method of adjusting systemic frequency in a storage device of the present invention, the method comprises the following steps:
a. a command is provided by a computer system to count the number of the clock pulses in a set time period of the computer system and the storage device;
b. the value of correction of the systemic frequency of the storage device is obtained by calculating in reference to the systemic frequency of the computer system, then the value of correction is stored in a storing medium; and
c. the systemic frequency of the storage device is adjusted by a system operating clock frequency adjusting unit according to the value of correction of the systemic frequency.

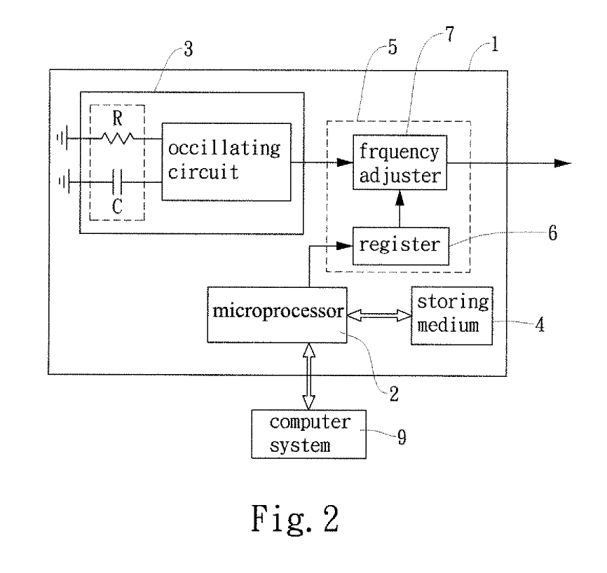

Referring to FIG. 2, the computer system 9 in the step a. firstly gives a command to a microprocessor 2 of the storage device 1 to command the microprocessor 2 to count the number of the clock pulses in a set time by an RC oscillating circuit 3, and to count the number of the clock pulses at the same set time of the computer system 9.

In the step b., when the computer system 9 gets the clock pulses of the computer system 9 and the storage device 1, it takes reference of the systemic frequency known by the computer system 9 itself at the same time, and obtains by calculating the systemic frequency of the storage device 1 according to the following formula:

the systemic frequency of the storage device=(the number of the clock pulses of the storage device/the number of the clock pulses of the computer system)×the systemic frequency of the computer system

When in practicing, the systemic frequency of the storage device 1 calculated is used as a value for correction for the systemic frequency of the storage device 1, the value of correction is stored in a storing medium 4 according to the command of the computer system 9; the storing medium 4 is a flash memory, and can be a hard disk or some other storing element.

And when in practicing, and after the computer system 9 obtains the systemic frequency of the storage device 1, the value of correction of the systemic frequency can be obtained by calculating in reference to the value of the systemic frequency to be obtained which is predetermined for the storage device 1, then the value of correction can be stored in the storing medium 4.

The step c. shows the actual state of the adjusting of the systemic frequency of the storage device 1; wherein the storage device 1 is provided therein with a system operating clock frequency adjusting unit 5, the system operating clock frequency adjusting unit 5 includes a register 6 in connection with itself and a frequency adjuster 7, the register 6 is connected with the microprocessor 2 of the storage device 1, the frequency adjuster 7 is connected with the RC oscillating circuit 3. When the RC oscillating circuit 3 in the storage device 1 starts to operate, under the control of the computer system 9, the value of correction of the systemic frequency is stored in the register 6 after being processed by the microprocessor 2, while the frequency adjuster 7 adjusts the systemic frequency output from the RC oscillating circuit 3 in the storage device 1 according to the value of correction of the systemic frequency stored in the register 6, thereby the systemic frequencies of the computer system 9 and the storage device 1 are matched with each other.

Further when in practicing, the frequency adjuster 7 is a digital frequency divider for changing the clock frequency of the RC oscillating circuit 3.

And when in practicing, the frequency adjuster 7 can also be a phase locked loop (PPL) which is preferably a phase locked frequency synthetic circuit for accurately adjusting the systemic clock frequency output from the RC oscillating circuit 3.

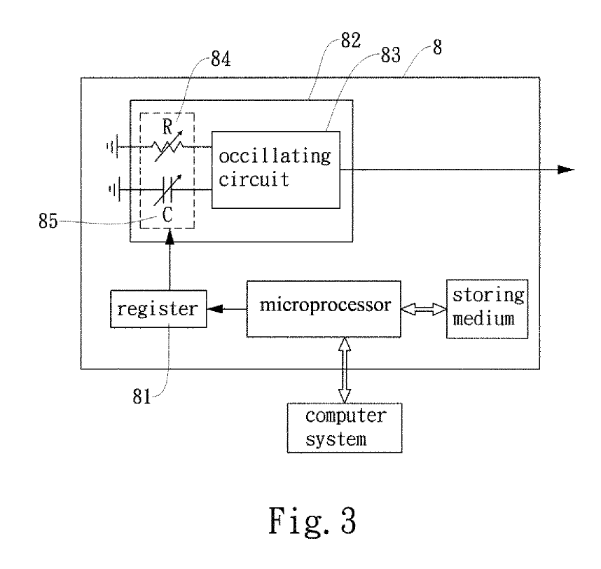

Referring to FIG. 3 which shows another way of practicing the step c., wherein a storage device 8 is provided therein with a register 81 and an adjustable RC oscillating circuit 82, the adjustable RC oscillating circuit 82 includes an oscillating circuit 83, a variable resistor 84 as well as a variable capacitor 85 in connection with each other, the register 81 can be connected with the variable resistor 84 and the variable capacitor 85. Thereby the variable resistor 84 and the variable capacitor 85 can have resistance and capacitance adjusted according to the above mentioned value of correction of the systemic frequency to thereby change the systemic frequency generated by the oscillating circuit 83.

Accordingly, the present invention has the following advantages:
1. The present invention can effectively control the systemic frequency of a storage device to be within a predetermined range to meet the requirement for a device with higher system performance specification.
2. The present invention can adjust the systemic frequency generated by the RC oscillating circuit in the chip by using a system operating clock frequency adjusting unit in the storage device after the systemic frequency for the chip is generated; this not only can avoid increasing extra time of testing chips or electronic components, and thereby can effectively reduce the cost of production.

In conclusion, according to the description disclosed above, the present invention surely can get the expected object thereof to provide a method of adjusting systemic frequency in a storage device, in which a structure built in the storage device is used to directly adjust the systemic frequency output from a chip to be within the range of a specification, and to reduce the cost of production.

While the embodiments given are only for illustrating the present invention; it will be apparent to those skilled in this art that various equivalent modifications or changes without departing from the spirit of this invention shall also fall within the scope of the appended claims.

Having thus described the technical process of my invention having high industrial value, what I claim as new and desire to be secured by Letters Patent of the United States is:

1. A method of adjusting systemic frequency in a storage device comprising:
a. a command being provided by a computer system to count number of clock pulses in a set time period of the said computer system and the said storage device;
b. a value of correction of the said systemic frequency of the said storage device being obtained by calculating in reference to the said systemic frequency of the said computer system, then the said value of correction being stored in a storing medium; and
c. the said systemic frequency of the said storage device being adjusted by a system operating clock frequency adjusting unit according to the said value of correction of the said systemic frequency.

2. The method as in claim 1, wherein
the said number of clock pulses of the said computer system and the said storage device are counted by a microprocessor of the said storage device.

3. The method as in claim 1, wherein
the said value of correction of the said systemic frequency is a value obtained by the said computer system by calculating according to the said systemic frequency of the said storage device, formula of calculation of the said systemic frequency of the said storage device is:
the said systemic frequency of the said storage device=(the said number of the said clock pulses of the said storage device/the said number of the said clock pulses of the said computer system)×the said systemic frequency of the said computer system.

4. The method as in claim 2, wherein
the said value of correction of the said systemic frequency is a value obtained by the said computer system by calculating according to the said systemic frequency of the said storage device, formula of calculation of the said systemic frequency of the said storage device is:
the said systemic frequency of the said storage device=(the said number of the said clock pulses of the said storage device/the said number of the said clock pulses of the said computer system)×the said systemic frequency of the said computer system.

5. The method as in claim 1, wherein
the said value of correction of the said systemic frequency is the said systemic frequency of the said storage device, formula of calculation of the said systemic frequency of the said storage device is:
the said systemic frequency of the said storage device=(the said number of the said clock pulses of the said storage device/the said number of the said clock pulses of the said computer system)×the said systemic frequency of the said computer system.

6. The method as in claim 2, wherein
the said value of correction of the said systemic frequency is the said systemic frequency of the said storage device, formula of calculation of the said systemic frequency of the said storage device is:
the said systemic frequency of the said storage device=(the said number of the said clock pulses of the said storage device/the said number of the said clock pulses of the said computer system)×the said systemic frequency of the said computer system.

7. The method as in claim 2, wherein
the said system operating clock frequency adjusting unit is connected with the said microprocessor, and the said system operating clock frequency adjusting unit includes a register for receiving the said value of correction of the said systemic frequency in order to adjust the said systemic frequency of the said storage device.

8. The method as in claim 7, wherein
the said system operating clock frequency adjusting unit further includes a frequency adjuster, the said frequency adjuster is connected with the said register of the said storage device to adjusts systemic frequency generated by an RC oscillating circuit in the said storage device.

9. The method as in claim 8, wherein
the said frequency adjuster is a digital frequency divider.

10. The method as in claim 8, wherein
the said frequency adjuster is a phase locked loop (PPL) circuit.

11. The method as in claim 7, wherein
the said storage device is provided therein with an adjustable RC oscillating circuit, the said adjustable RC oscillating circuit is connected with the said register for adjusting and outputting the said systemic frequency of the said storage device.

12. The method as in claim 11, wherein
the said adjustable RC oscillating circuit includes an oscillating circuit, a variable resistor as well as a variable capacitor in connection with each other, the said register is connected with the said variable resistor and the said variable capacitor for adjusting RC values to thereby change systemic frequency generated by the said oscillating circuit.
